(19) United States
(12) Patent Application Publication
(10) Pub. No.: US 2013/0199063 A1
(43) Pub. Date: Aug. 8, 2013

(54) MULTI RETRACTABLE BANNER

(71) Applicants: Gail A. Buffington, Des Moines, IA (US); Nicholas A. Buffington, Des Moines, IA (US)

(72) Inventors: Gail A. Buffington, Des Moines, IA (US); Nicholas A. Buffington, Des Moines, IA (US)

(21) Appl. No.: 13/759,378

(22) Filed: Feb. 5, 2013

Related U.S. Application Data
(60) Provisional application No. 61/595,388, filed on Feb. 6, 2012.

(51) Int. Cl. G09F 11/21

(52) U.S. Cl. CPC G09F 11/21
USPC 40/515

(57) ABSTRACT

A banner assembly having a housing with an elongated slot. A plurality of rollers mounted to adjustable brackets disposed within the housing. A plurality of sheets attached to and wrapped around the roller that extend through the elongated slot.

### CROSS REFERENCE TO RELATED APPLICATION

This application claims the benefit of U.S. Provisional Application No. 61/595,388 filed Feb. 6, 2012.

### BACKGROUND OF THE INVENTION

This invention relates to advertising. More specifically, this invention relates to a multi retractable banner.

Currently, in department stores that sell fashion products such as dresses, sweaters, skirts and the like have a window front and signs within the store advertising its fashion apparel. One manner in which signs can be displayed including within a window is through the use of a retractable banner that holds one or two signs and are pulled up from the floor onto a stand. Most retailers use a paper banner that must be inserted into a frame or attached to plastic strips for hanging.

While this presents a manner in which advertising can be displayed problems in the art remain. Specifically, current retractable banners set too low to the ground to be used as a proper window display. Thus, current window banners are easily damaged and the process of changing out the signs is labor intensive and time consuming. To that end, with every change that must be made by store employees the chance for injury of an employee increases resulting in workman compensation claims and inefficiencies.

Thus, a need in the art exists for an improved manner of advertising within department and retail stores.

An objective of the present invention is to provide a retractable banner that is better suited for window displays.

Another objective is to provide a retractable banner that is easier to change out signs.

These and other objectives will be apparent to one of ordinary skill in the art based upon the following written description, drawings and claims.

### BRIEF SUMMARY OF THE INVENTION

A banner assembly having a housing having a first housing member hingedly connected to a second housing member to form a hollow interior. Disposed within and mounted to adjustable brackets are a plurality of retractable rollers. A plurality of sheets fit within slots on the rollers at a first end, wrap around the rollers and extend through an elongated slot in the housing. Attached to a second end of the sheet is a weighted handle.

### BRIEF DESCRIPTION OF THE DRAWINGS

FIG. 1 is a side view of a banner assembly; and

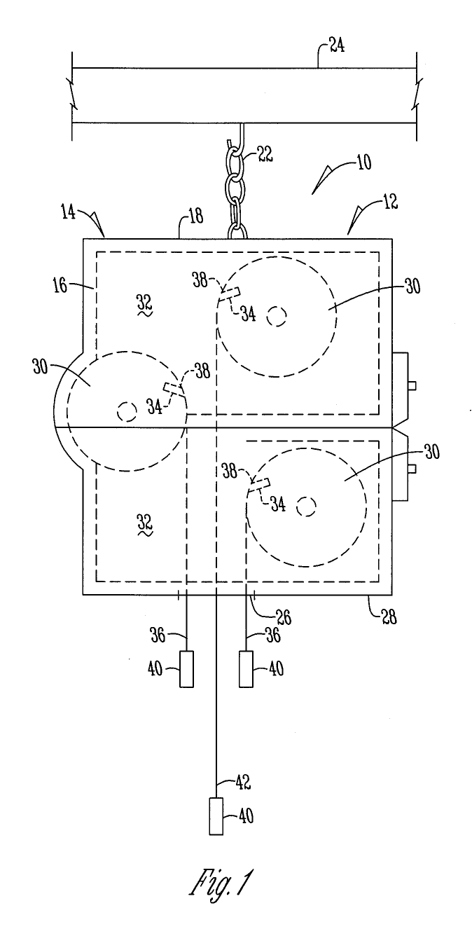

FIG. 2 is a front plan view of a banner assembly.

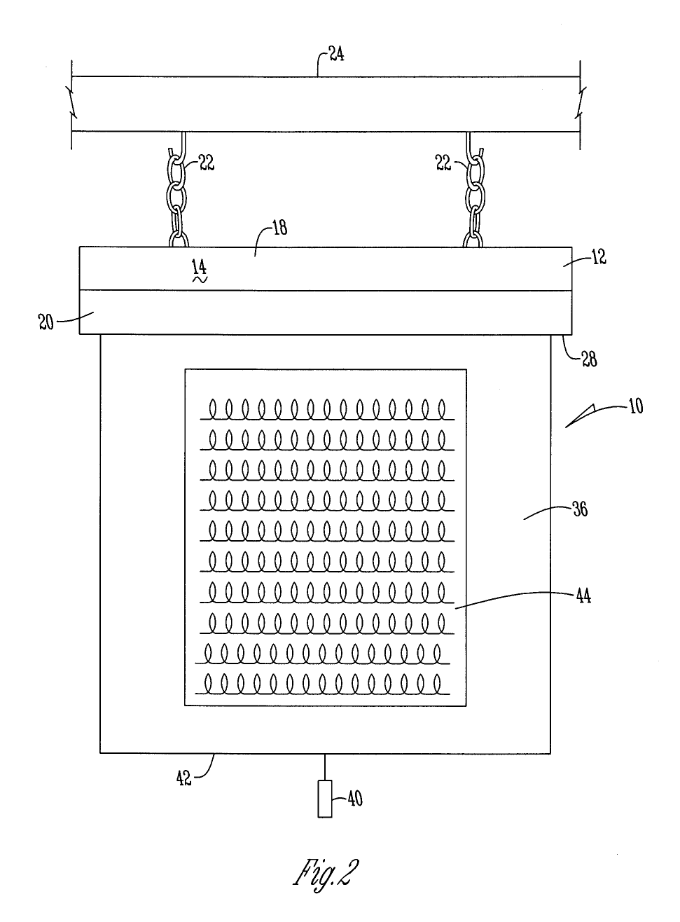

### DETAILED DESCRIPTION OF THE PREFERRED EMBODIMENT

The figures show a banner assembly 10 that has a housing 12 having an exterior 14 surrounding a hollow interior 16 created by first 18 and second 20 housing members that are hingedly connected to one another with the first 18 and second 20 housing members separated from one another to access the interior 16 of the housing. Secured to the first housing member 18 is at least one attachment element 22 such as a eyelet connector, chain, strap, combination of an eyelet connector and chain or the like that can be used to attach the housing 12 to a movable frame or other exterior body 24 to allow the housing 12 to hang from the exterior body 24. The second housing member 20 meanwhile has an elongated slot 26 running the length of the bottom 28 of the second housing member 20.

Within the interior 16 of the housing 12 are a plurality of elongated rollers 30 that are rotatably connected to adjustable bracket members that are secured to the interior of the housing and have slots 34 to detachably receive the rollers 30. The brackets 32 are offset from one another and are presented in a downward angle to maximize the amount of rollers 30 that can be placed within the interior 16 of the housing 12. Specifically, the interior 16 of the housing 12 houses at least three rollers 30 and in other embodiments more than three rollers.

The plurality of rollers 30 all have a sheet 36 preferably made of vinyl attached thereto that rolls around each roller 30 element at a first end 38 and has a handle 40 at a second end 42 that in a preferred embodiment is V-shaped and metal to allow for gripping by an individual. In addition, each roller 30 is retractable such that when the sheet 36 is pulled to the fully extracted position it may be pulled downwardly and then retracted up around the roller 30 within the housing 12. Each of the sheets 36 is disposed through the elongated slot 26 located along the bottom surface 28 of the second housing member 20 and thus may be easily accessed.

The sheets 36 are made of a material that allows peel and stick sign indicia 44 to be placed onto the sheet 36. Specifically, peel and stick indicia 44 is an indicia that is pressed onto a surface and when peeled off a material is left on a surface that is detachably adhered to the surface so that the indicia 44 itself may also be peeled off.

In operation, an individual takes advertising that is presented in a peel and stick indicia 44 and places it onto a sheet 36. Each sheet 36 of the plurality of rollers 30 is then imprinted with different advertisements and rolled up into the housing. The banner assembly 10 is then placed in the desired location for the advertising such as a store front window within the store or the like. At that time an individual only need to walk up to the banner assembly 10 and pull the desired advertisement down from within the housing 12. At this point in time the metal handle 40 weighs down the sheet 36 to hold it in place and the desired advertising is presented.

At a time when the advertising needs to be changed a worker only need to retract the current sheet 36 and pull down the next advertising sheet without having to change banners or any additional complicated processes. Then, this procedure can occur again for a third, fourth and as many times as there are rollers within the housing. Once advertising on a roller 30 has gone out of style or an offer is no longer being provided, the housing 12 is opened and the sheet 36 may be extracted so the stick and peel indicia can be removed from the sheet 36. Then a new stick and peel indicia is placed onto the sheet 36 and thus another set of advertising sheets can easily be provided.

Thus, presented is an advertising assembly that allows for quickly changing advertising within a department store. By having a plurality of rollers and specifically three or more within the housing, advertisements can continuously be changed without having to change rollers, take apart the system or other time consuming and potentially dangerous activities. As a result time is saved, efficiencies are improved, and work injuries are minimized. In addition, as a result of the peel and stick replacement in combination with the use of the vinyl, again changing out advertisements is efficient and safe. Thus, at the very least all of the stated problems have been overcome.

What is claimed is:

1. A banner assembly, comprising;
a housing having an elongated slot;
a plurality of retractable rollers mounted within the housing;
a plurality of sheets wrapped around the plurality of rollers and the plurality of rollers at one end that extend through the slot and are attached to a plurality of handles at the opposite end.

2. The banner of claim 1 wherein the housing has a first housing hingedly connected to a second housing.

3. The banner assembly wherein an attachment element is secured to the housing.

4. The banner assembly of claim 1 wherein the rollers are mounted to adjustable bracket members.

5. The banner assembly of claim 1 wherein the rollers have a slot that receives a first end of the sheets.

6. The banner assembly of claim 1 wherein the handle is weighted.

7. The banner assembly of claim 1 wherein the sheets have peel and stick indicia.
